(19) United States
(12) Patent Application Publication
(10) Pub. No.: US 2014/0103065 A1
(43) Pub. Date: Apr. 17, 2014

(54) NON-CORING REDUCED SHEARING NEEDLE

(71) Applicant: CORAVIN, LLC, Burlington, MA (US)

(72) Inventors: Gregory Lambrecht, Natick, MA (US); Sean Kavanaugh, Boston, MA (US); Nicholas G. Lazaris, Newton, MA (US); Otto Deruntz, Dunstable, MA (US); Adam Brierley Craft, Mansfield, MA (US); Mike Rider, Lowell, MA (US)

(73) Assignee: Coravin, LLC, Burlington, MA (US)

(21) Appl. No.: 13/793,403

(22) Filed: Mar. 11, 2013

Related U.S. Application Data
(60) Provisional application No. 61/795,225, filed on Oct. 12, 2012.

(51) Int. Cl. B67D 1/00

(52) U.S. Cl. CPC B67D 1/0042; B67D 1/0004
USPC 222/81; 163/5

(57) ABSTRACT

Method and apparatus for beverage extraction needle side holes or apertures. The leading and trailing edges of the apertures may be shaped or otherwise configured to help reduce the possibility of coring or shearing of material as the needle is inserted into and/or withdrawn from material, such as a cork. Convex leading and/or trailing edges may help deflect material away from the aperture, reducing shearing. Concave leading and/or trailing edges may help prevent entry of material into the aperture, again reducing shearing.

This application claims the benefit under 35 U.S.C. §119(e) of U.S. provisional application No. 61/795,225, filed Oct. 12, 2012, which is incorporated by reference herein in its entirety.

### FIELD OF THE INVENTION

This invention relates to needle designs, e.g., for needles adapted to penetrate a corked vessel such as a bottle of wine for accessing its contents.

### BACKGROUND

Devices for extracting wine or other beverage from a corked or similarly closed bottle are described in U.S. Pat. No. 8,225,959. These devices operate by inserting a needle through a bottle cork without removing the cork, dispensing beverage from the bottle, and withdrawing the needle from the cork. In some arrangements, the cork may reseal upon withdrawal of the needle, thus allowing the beverage to be dispensed without exposing the bottle interior.

### SUMMARY OF INVENTION

The inventors have found that closed tip needles with side holes can be particularly useful in applications like that described in U.S. Pat. No. 8,225,959, both for simplicity of use given their unitary structure, and due to their tendency to travel straight through the material being penetrated. This is in contrast to deflected tip needles, which may skive or deflect while traversing material. Closed tip needles penetrate a material using a sharpened or pointed closed tip which then dilates the material out of the way as the needle passes through. Side holes along the needle's length may allow for flow into and through the needle once the side holes have reached the far side of the material being penetrated.

In single lumen needles, the smallest flow area is generally defined by the inner diameter of the needle. However, in the case of a closed tip needle employing a side hole, the side hole itself is generally the minimum flow area or otherwise provides the greatest resistance to flow. This is because as the area of the side hole increases, there is an increasing risk that material can fall into the side hole, or can be planed, sheared, cut or cored by the edges of the side hole as the needle progresses through the material. This is particularly true if the material being traversed is under compression or constrained against expansion, as is often the case with a wine bottle cork. In such cases, dilation of the material by the closed needle tip results in compression of the material against the outer diameter of the needle. This compression is partially relieved as the material passes over the needle side hole by expansion of the material toward the inner diameter of the needle, putting this material at risk of being cut, cleaved, sheared, planed or laterally cored when it contacts the advancing edge of the side hole. This shearing risk scales with side hole area as well as increasing outer diameter of the needle. Increasing side hole area provides more room for expansion of the compressed material toward the inner bore of the needle, and larger needle diameters increase the compression of the traversed material against the outer surface of the needle, hence increasing the propensity for the material to expand into the side hole. Coring, cleaving, planing, or shearing off of material can occur both on insertion and removal of the needle, as both the leading and trailing edges of the side hole may engage material the edge is advanced through the material. To prevent or reduce such coring risk, needle side holes may be made less than the cross-sectional flow area of the needle bore, creating an unwanted flow restriction but avoiding unwanted blockage of the needle side holes by sheared off cork or other material.

Aspects of the invention provide for maximized or otherwise enhanced flow through closed-tip needles having one or more side holes while limiting the coring, cleaving, planing, or shearing off of the material being traversed by the side holes. By limiting shearing of material by the needle side hole(s), damage to the material may be reduced and clogging of, or the collection of debris within, the needle bore can avoided. In some embodiments, edges of the side holes may be deflected inwardly away from the outer surface of the needle or tapered inwardly, either around the entire circumference of the side hole, or at least at those regions of the edge that are transverse to the direction of needle insertion and/or removal. In other embodiments, edges of the side holes may be deflected outwardly away from the outer surface of the needle, e.g., by building up the edge of the hole away from the outer surface of the needle or deflecting the edges outwardly away from the needle center. Other techniques for reducing material shearing disclosed herein include shaping and positioning the side holes relative to the tangency of the needle body and tip, and sizing the side holes with respect to the needle bore dimensions. In some embodiments, a needle side hole can be shaped such that its leading and trailing edge possess a convex profile in two dimensions and tapered edges. Also, the leading and trailing edge of the side hole may be joined by two parallel edges.

These and other aspects of the invention will be appreciated from the following description and claims.

### BRIEF DESCRIPTION OF THE DRAWINGS

FIG. 1A is a front view of a prior art non-coring needle and hub assembly employing a pencil point or conical needle tip.

FIG. 1B is an enlarged cross-sectional view of the FIG. 1A needle tip or distal end showing a section of two side holes located on either side of the needle circumference at a same distance from the needle tip.

FIG. 1C is an enlarged side view of the FIG. 1B needle tip region.

FIG. 2 is a cross-sectional side view of a needle tip with opposing apertures or side holes and depicts one method of forming a needle side hole by deflecting at least a portion of the edges of the side holes toward the inner diameter of the needle cannula using a pair of anvils.

FIG. 3A is a cross-sectional view of a distal tip region of a needle in which the leading and trailing edges of the side holes are deflected toward the inner diameter of the needle.

FIG. 3B is a side view of the needle in the FIG. 3A embodiment.

FIGS. 4A-D illustrate sequence of a needle being inserted into a block of material along a linear path parallel to the long axis of the needle and shearing material. FIG. 4A shows a front view of a needle prior to insertion. FIG. 4B is a cross-sectional enlarged view the needle tip advancing into the material and being dilated out of the path of the needle by the conical needle tip, but falling back into the side holes. FIG. 4C is a cross-sectional enlarged view of the further progression of the needle into the material and the resulting cutting or shearing of the material within the side holes by the trailing edge of the side holes. FIG. 4D is a cross-sectional enlarged view and depicts the same shearing phenomenon caused by the interaction of the material and the leading edges of the side holes during removal of the needle from the material.

FIGS. 5A and 5B illustrate a different sequence of a needle in accordance with an aspect of the invention being inserted into a block of material along a linear path parallel to the long axis of the needle in which the shearing of material is avoided. FIG. 5A is a cross-sectional enlarged view of the needle and depicts dilation of the material by the conical needle tip with the material falling into the side holes during insertion of the needle along a linear path parallel to the needle's long axis. FIG. 5B is a cross-sectional enlarged view of the needle and depicts the material riding up the deflected trailing edges of the side holes without cutting or shearing of the material.

FIGS. 6A and 6B are a cross section and side view, respectively, of the distal region of an alternative embodiment of a needle with a deflected-edge side hole. The deflection is accomplished by the addition of a raised ridge around the circumference of the side holes extending outward from the outer surface of the needle cannula.

FIGS. 7A and 7B are a cross section and side view respectively of the distal region of an alternative embodiment of a needle with a deflected-edge side hole. The deflection is accomplished by the addition of a raised ridge around the circumference of the needle proximal and distal to the side holes.

FIGS. 8A and 8B are cross-sectional views of a needle tip and plug assembly. FIG. 8C is a front view showing the plug within the needle tip and providing a deflection surface within the needle side hole.

FIG. 9A is a front view of a needle and shows a tip and side hole in another embodiment. FIG. 9B is a cross-section view of the FIG. 9A needle.

FIG. 10A and B are front and side views of the needle in FIGS. 9A and 9B with exemplary dimensions included.

FIG. 11A is frontal view of a needle and shows a tip and side hole. FIG. 11B is a cross-section view of the FIG. 11A needle.

FIG. 12A and B are front and side views of the needle in FIGS. 11A and 11B with exemplary dimensions included.

FIG. 13A is front view of a needle and shows a tip and side hole in another illustrative embodiment. FIG. 13B is a cross-section view of the FIG. 13A needle.

FIG. 14A and B are front and side views of the needle in FIG. 13A with exemplary dimensions included.

FIG. 15A is a front view of a needle with a septum bifurcating the opposing side apertures of a needle. FIG. 15B is a side view of the FIG. 15A needle. FIGS. 15C and 15D are a front and side view of a needle tip plug with a lower base and upper septum member.

### DETAILED DESCRIPTION

Often, the smallest flow area in standard needle cannulae is defined by the inner diameter of the needle. However, in the case of a closed tip needles employing a side hole, the side hole itself generally defines the minimum flow area. This is because as the area of the side hole increases, there is an increasing risk that material can fall into the side hole and be planed, sheared, cut or cored by the edges of the side hole as the needle progresses through the material. This is particularly true if the material being traversed is under compression or constrained against expansion.

One or more aspects of the present invention relates to methods and devices to maximize flow rate through non-coring needles while minimizing the risk of cleaving, cutting or shearing the material being traversed. More specifically, one or more aspects of the present invention relate to methods of modifying the geometry of the edges of side holes in a non-coring needle to maximize flow area while minimizing the risk that material will be cut, sheared or cored by the edge of the side hole. Certain embodiments of the invention relate to needles with deflected side hole edges and methods for forming thereof. Other embodiments of the invention involve shaping the needle side hole such that its leading and trailing edge possess a convex profile in one or more dimensions and by connecting the leading and trailing edge of the aperture with two parallel edges.

Needles presented herein are generally made from stainless steel, though other metals, alloys of metals, composites, plastics, and ceramics could be used. Needle gauges or outer diameters can typically range from 15-19 gauge, but preferably are around 17 for the cork and septum applications described herein. Much greater or larger gauges for different applications depend on the material being penetrated, desired flow, aperture size, and the tolerability of particulate shearing. The conical tip of certain embodiments of non-coring needles described herein may be formed in a variety of ways including swaging, forming, molding, and casting. The angle of the tip or facets thereof whether closed conical, stylet, corrugated, bladed, or pyramidal may be from 15-20 degrees and preferably 18 degrees included. Alternatively, the tip may be defined as an arcing or curved surface wherein the distal portion of the needle decreases in diameter over a length of between 0.05 and 0.2 of an inch. Needle hubs, i.e., components used to engage the needle with another device such as a beverage extraction device, may be integral to the needle and formed of the same material or separate and formed of the same material or different material such as nickel plated brass. Needle length is generally a function of the depth of penetration desired through a material and the size and position of the side hole or aperture since that feature must necessarily pass beyond the material to achieve the desired flow. Though longer needles may be desirable since they may enable less tilting of a bottle needed for dispensing, generally shorter needles are desirable as having more overall strength and integrity. Accordingly, needles herein can range from about 1-12 inches preferably around 2-4 inches in length.

In one exemplary method of forming needles described herein a needle shaft is formed via extrusion and then the tip is formed through swaging. The opposing holes or apertures are formed by die-sinker EDM, wire EDM, ECG, punch, or via a rotating bit. The aperture(s) may be honed, polished, electro-polished or chemically polished. Thereafter the needle may be secured to a hub through press-fitting, swaging, brazing or welding. The needle may be passivated and grit blasted and coated with a lubricious material such as Teflon or the like.

The various rings, plugs, hubs, septums and needle features described above can be fabricated from the same material as the needle. Alternatively they could be fabricated from or plated with a different material. Various potential materials include but are not limited to any of a variety of metals, such as brass, tin, zinc, copper, nickel titanium, or alloys of steel, as well as rigid or flexible polymers such as acetyl, ABS, PET, Teflon, silicone, rubbers, poly glycolic or poly lactic acids or the like. Alternatively, they may be made from combinations or constructs involving multiple materials. The materials may be permanent or dissolvable. They may be bonded to the needle by glues, or may be press fit, welded, soldered or brazed to the needle.

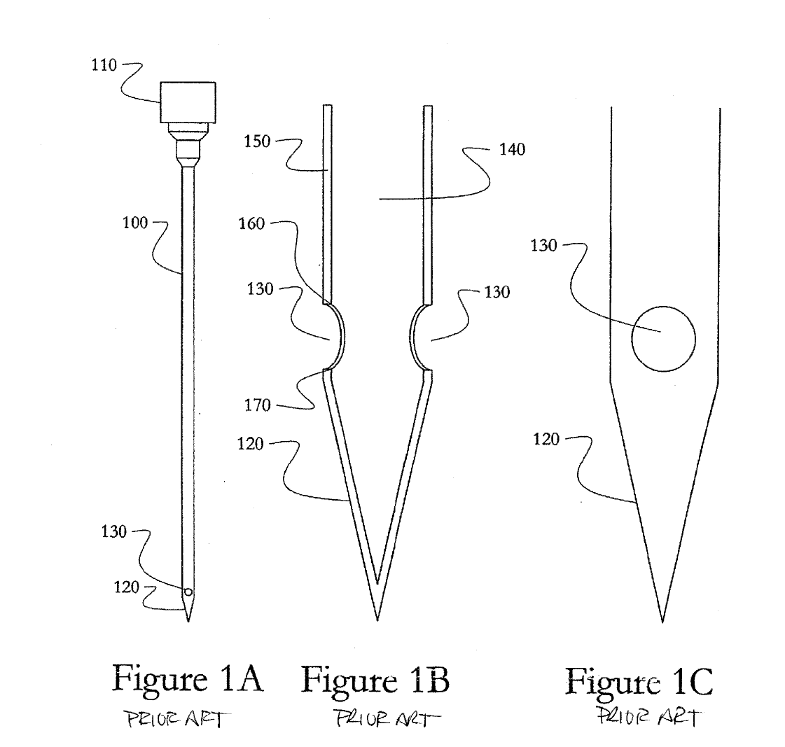

FIGS. 1A-1C depict a non-coring needle and will be used for purpose of discussing flow rate considerations. The needle 100 employs a closed conical or pencil tip 120 at a distal end, one or more side holes 130 proximal to the distal tip 120 cut or ground into and through the wall of the needle cannula or body 150, and a hub 110 at the needle's proximal end. The needle is designed to be inserted through a material along a linear path parallel with the long axis of the needle. The conical tip 120 pierces and dilates the traversed material, while the side hole or holes 130 provide access for flow into or out of the central bore 140 of the needle cannula or body. The hub 110 allows for secure fluid connection to another device such as a syringe and can be one of a variety of commonly available connections such as threaded or Luer. The side hole 130 has a leading edge 170 and a trailing edge 160. The optimal size of the side hole to achieve maximal flow is that which provides a flow area at least as large as the flow area defined by the inner diameter of the needle bore 140. For example, in needles with circular cross sections, the flow area of the bore 140 is simply the square of the inner diameter of the bore times pi divided by four. In this example, the area of the side hole that provides minimal increased resistance to flow would be at least equivalent to this area.

The side hole in the embodiment depicted in FIGS. 1A-1C is circular. However, in accordance with aspects of the invention, elongated holes whose maximum dimension is along the long axis of the needle can be used to maximize flow area while minimizing the length of the side hole edges perpendicular to the insertion path, or the length of the leading and trailing edges. The leading and trailing edges 170, 160 of the side hole are the most likely to cut or shear material that extends into the central bore of the needle during linear insertion and removal, as long as the needle is not rotated about its long axis during insertion/removal.

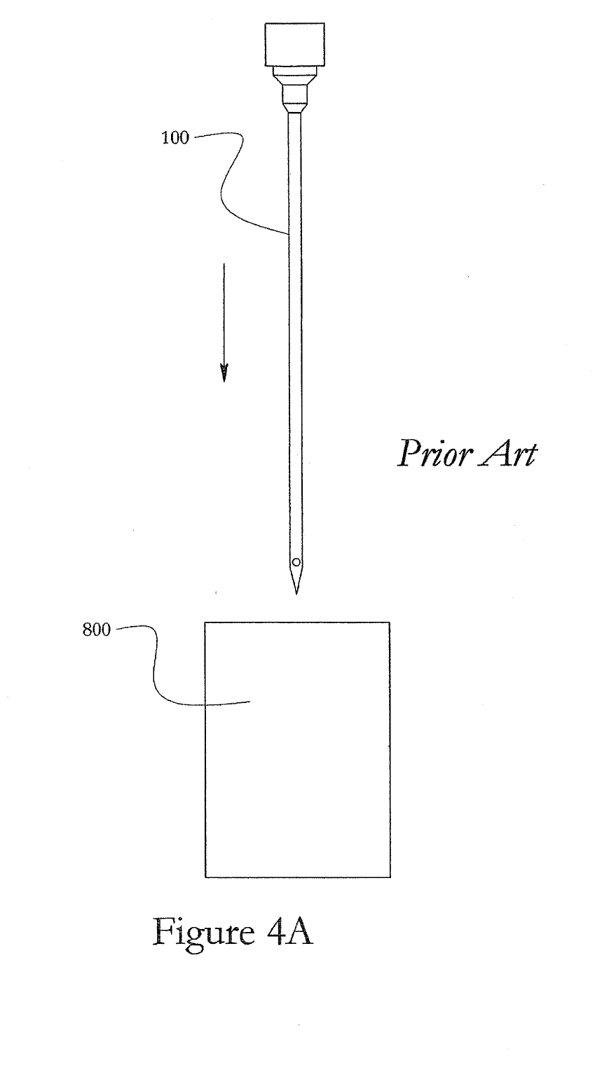

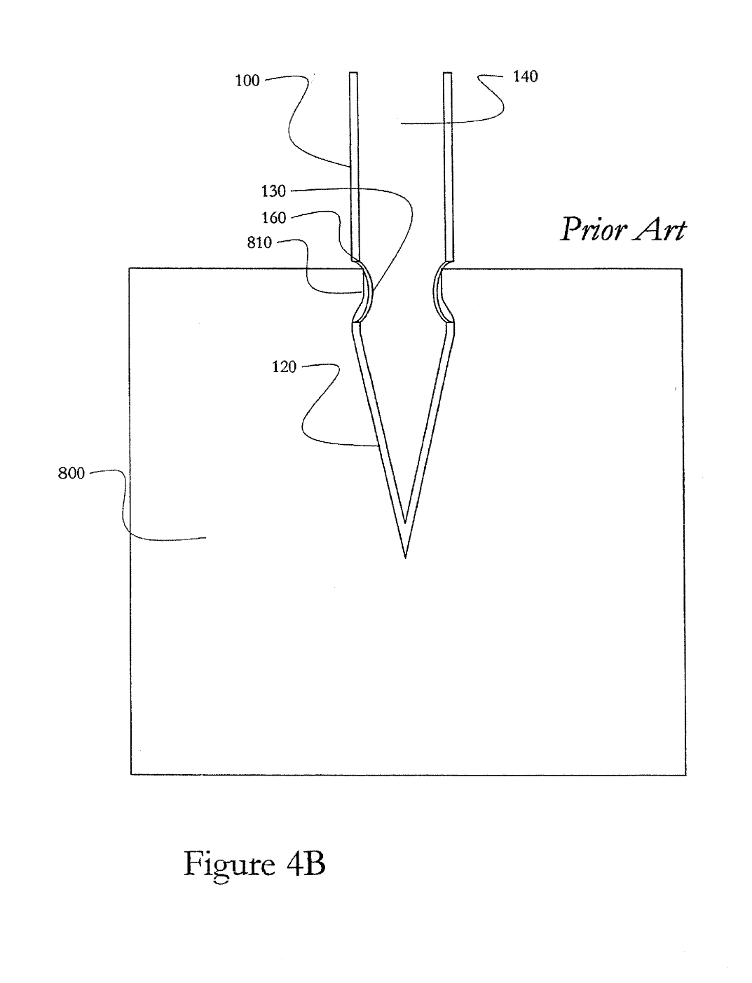

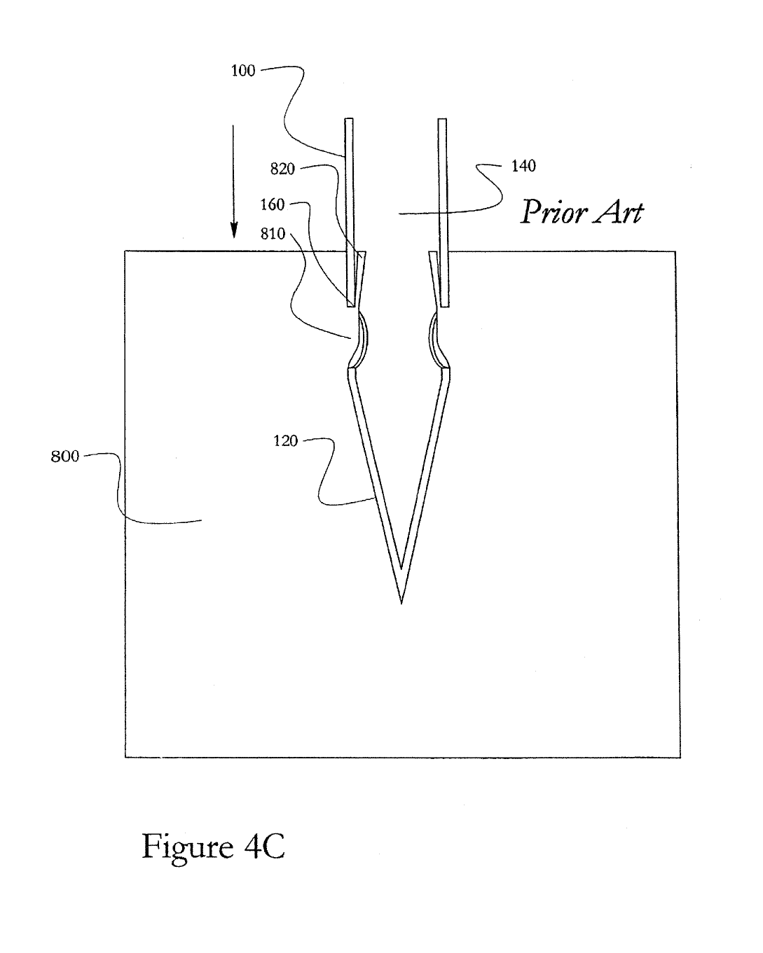

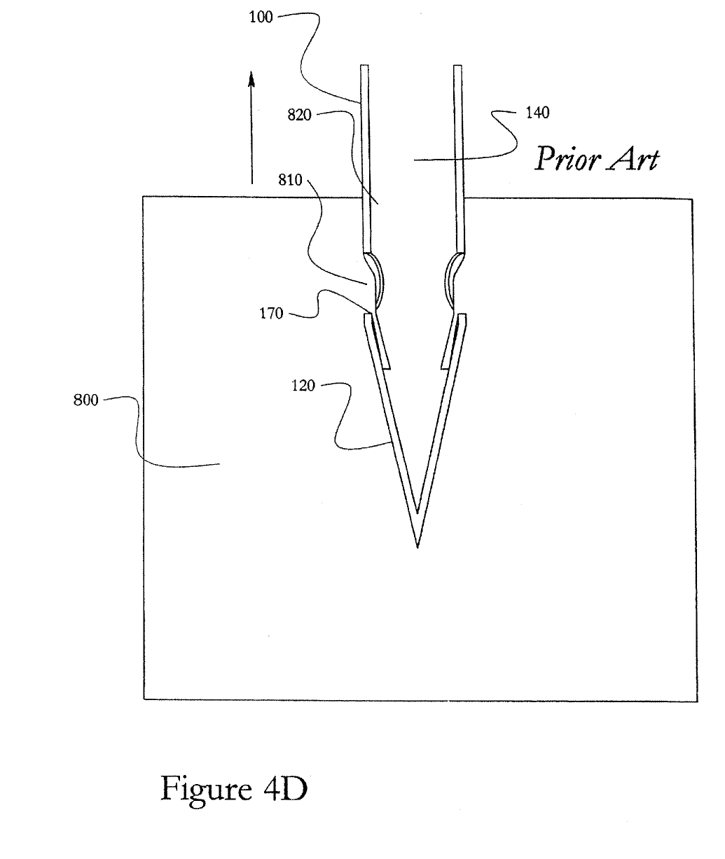

FIGS. 4A-D depict the needle embodiment of FIGS. 1A-1C during insertion and removal from material 800, such as a bottle cork, and will be used to illustrate instances of shearing, cleaving or planing of the material during insertion and removal. Material 800 may be any of a variety of elastic materials suitable for sealing a flow path, such as a silicone or rubber plug, a natural or synthetic cork, or the like. The material may be free as depicted or constrained and/or compressed within a flow path, blocking that flow path from the passage of fluids such as liquids or gasses.

Needle 100 enables flow through material 800 once side holes 130 are located on a far side of the material and hub 110 is on the near side. Fluid can then flow into or out of the inner bore of the needle 140 through the side holes and hub.

FIG. 4A shows needle 100 positioned above material 800 with tip 120 toward the material. The needle is then advanced into the material such that conical tip 120 pierces the material and dilates it radially outward, creating compression of the material against the outer surface of the needle as it passes through the material. As shown in FIG. 4B, the compressed material 810 can relieve compression by expanding into side holes 130 during insertion. As the needle tip is advanced further into the material in FIG. 4C, this expanded material 810 can be cut by the trailing edge 160 of side hole 130 formed by the cut edge of needle wall 150, creating material fragment 820. This fragment can obstruct the central bore 140 of the needle and results in unwanted damage of material 800, potentially hampering flow and/or deteriorating material 800's further ability to seal against the flow of fluids once needle 100 is withdrawn. Removal of needle 100 from material 800 can create further material fragments as the compressed material within side hole 130 again is cut by the leading edge 170. As previously described, the risk of creating material fragments 820 is increased by increasing side hole area and by compression or constraint of material 800. This risk is also increased by the durometer or hardness of material 800, its propensity to fragment, and by the thinness of needle wall 150. Thin wall needles decrease flow resistance for a given outer diameter. However, the thinner the wall, the less material 800 must expand into the central bore 140 to be cut by leading edge 170 or trailing edge 160.

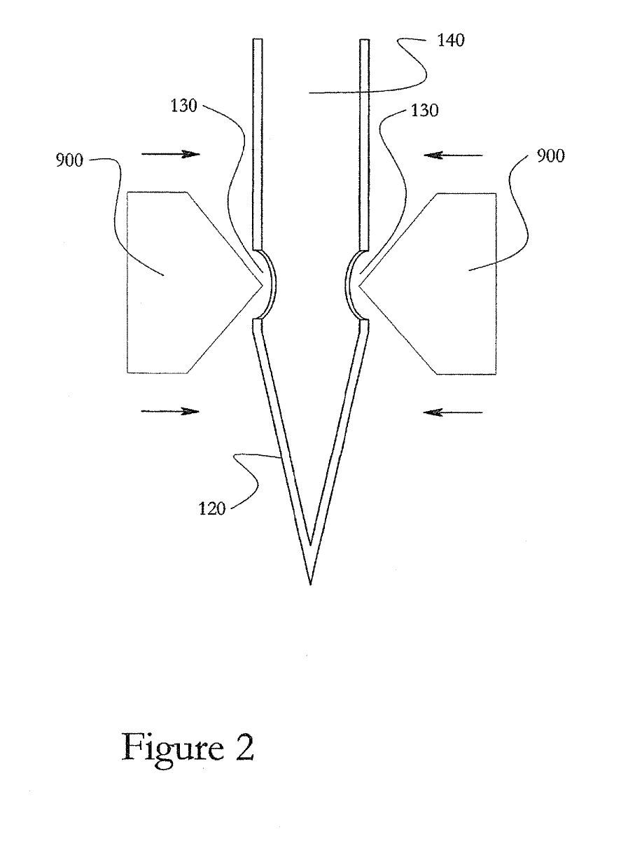

In one embodiment of the invention, one or more needle apertures or holes is formed having particular leading and trailing edge profiles. FIG. 2 depicts one preferred method of forming (e.g. swaging) the leading and trailing edges of side hole 130 to decrease the risk of cutting or shearing traversed materials. In this method, anvils 900 are driven radially inward toward the centers of holes 130. Such a conical anvil makes contact with the needle wall first at the leading and trailing edges of the side holes 130. As the anvils are advanced, these edges are deflected inwardly toward the central bore 140, creating a ramped surface at the leading and trailing edges. As a result, the leading and trailing edges of the side holes 130 may be concave, helping to reduce the possibility that the edges contact and shear cork or other material as the needle is moved through the material.

Anvils 900 may be rotationally symmetric cones. Alternatively, anvils 900 may simply be angled wedges, flattened cone sections, or a simple stepped diameter in a rod from a diameter smaller than side hole 130 to a larger diameter. Such alternate anvil shapes may be useful for forming particular deflected shapes or deflections in only small regions of the leading and trailing edges. Anvils 900 may impart the same deflection to both the leading and trailing edges. Alternatively, the anvils may be formed to provide different deflections to the leading and trailing edge.

The method depicted is shown employing only anvils to form the deflection. Alternatively, the anvils could work in concert with an additional anvils or mandrels inserted within the central bore of the needle. Such a mandrel could be used to impart controlled deflected shapes to the hole edges, and/or to limit the progression of anvils 900 into the central bore of the needle. The method depicted shows the simultaneous forming of two opposite side holes. Alternatively there may be only one or a multitude of side holes that could be deflected either simultaneously or in series. Further, each of the leading and trailing edges could be formed individually.

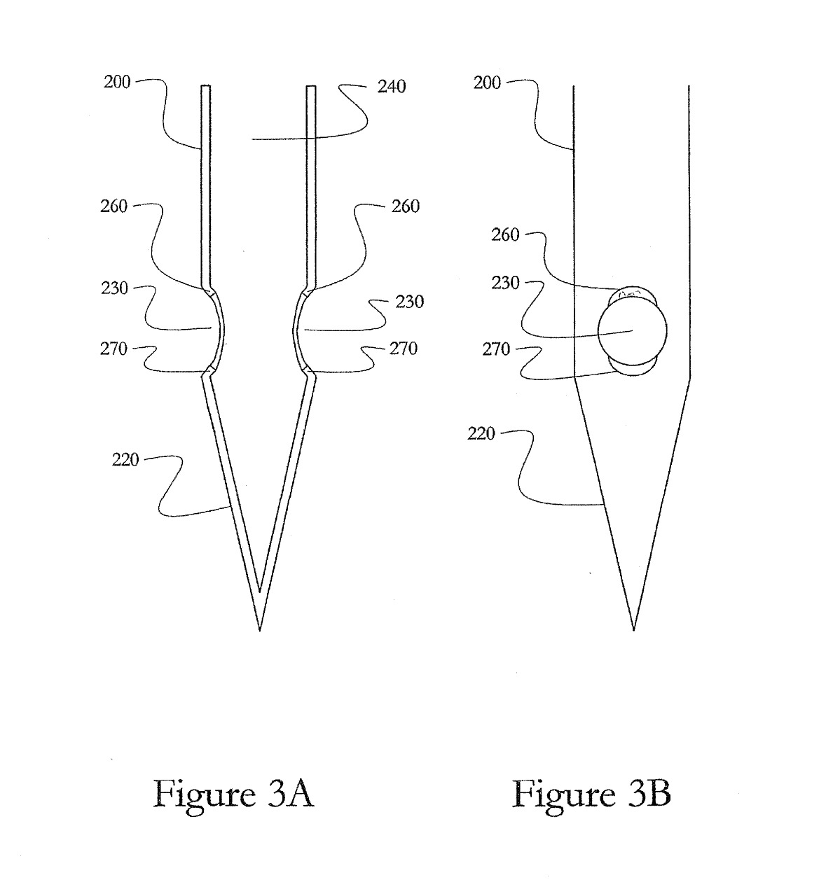

The result of the forming method described FIG. 2 is shown in FIGS. 3A and 3B. Both leading edges 270 and trailing edges 260 are deflected toward needle bore 240, forming small concave (conic sectional) ramps at the leading and trailing edges. Such ramps may define a surface with an angle relative to the needle wall of about 10-45 degrees. The resulting deflected shape is shown as semi-lunate in side view as seen in FIG. 3B and is formed in the regions of the side hole most likely to cut or shear a material traversed by the needle along a path co-linear with the long axis of the needle. These deflected ramps effectively blunt and elongate the leading and trailing edges, decreasing the risk of cutting the traversed material, while only minimally diminishing the flow area of central bore 240 in the region of trailing edge 260. Edge 270 is distal to the flow path and so does not increase resistance to flow through the needle.

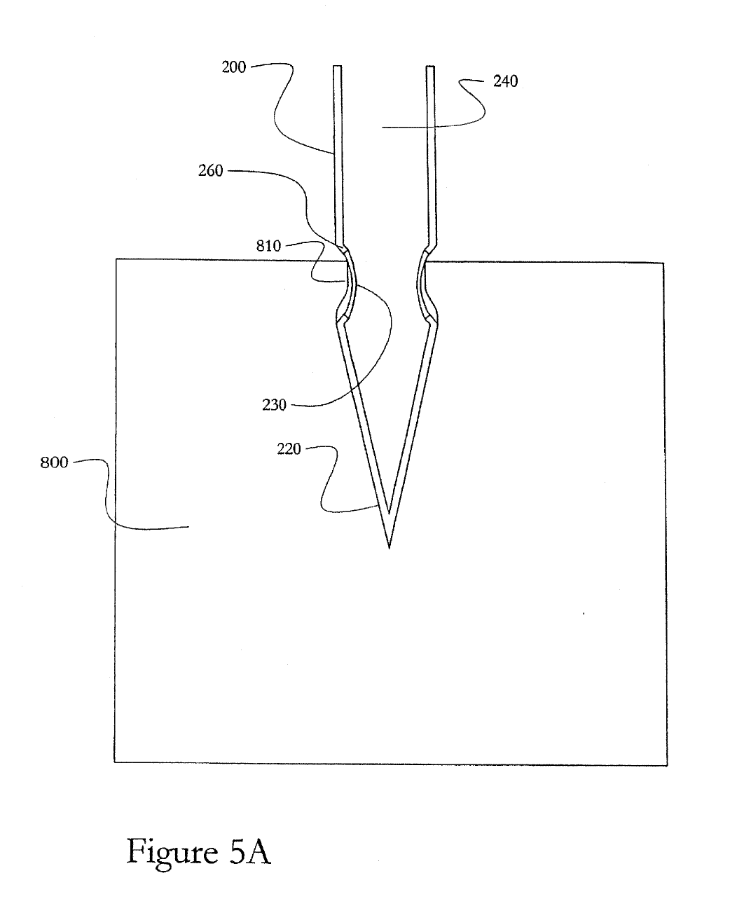

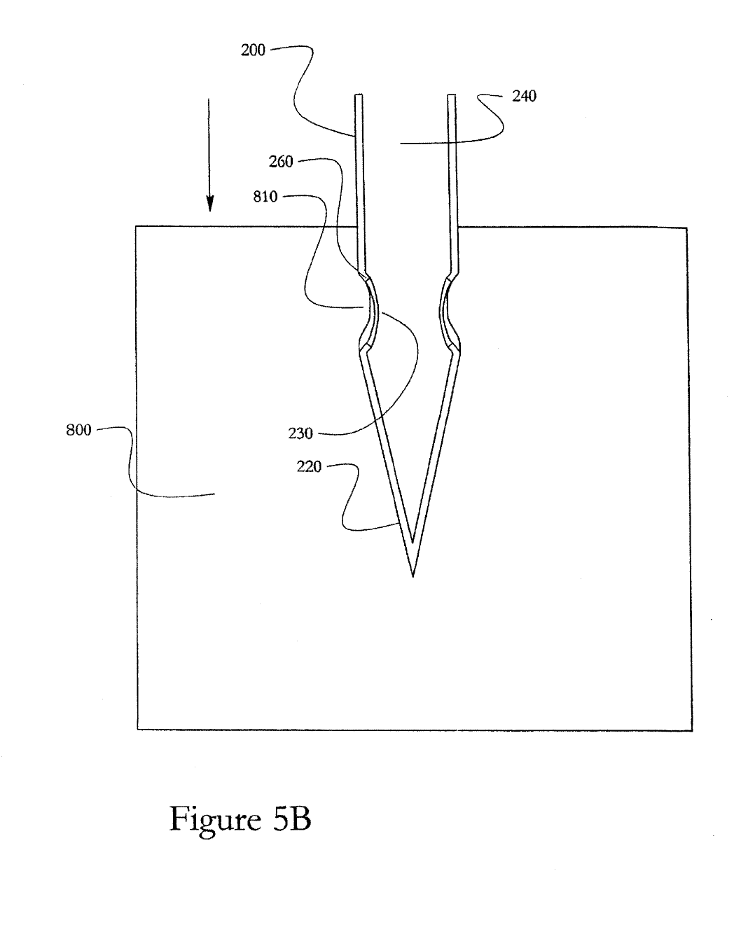

FIGS. 5A and 5B depict needle 200 of FIGS. 3A and 3B traversing material 800. As the material expands into side holes 230, the ramped, deflected trailing edge 260 allows material 810 to pass without cutting or shearing. Although not shown, the same is true upon removal of the needle. Ramped, deflected leading edge 270 allows material 810 to pass without creating cut fragments of material 800.

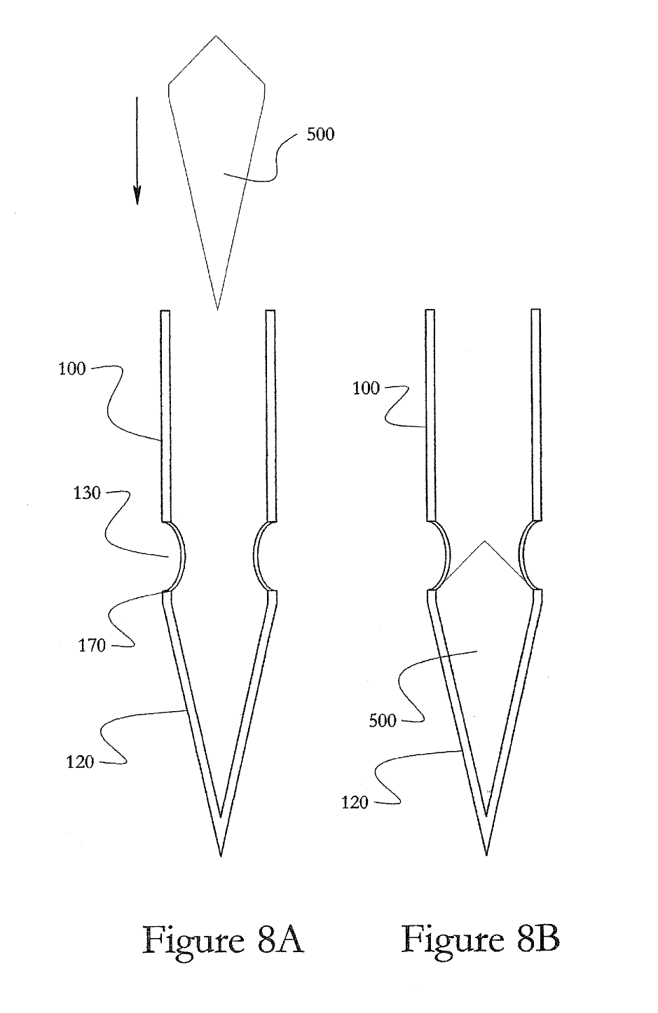

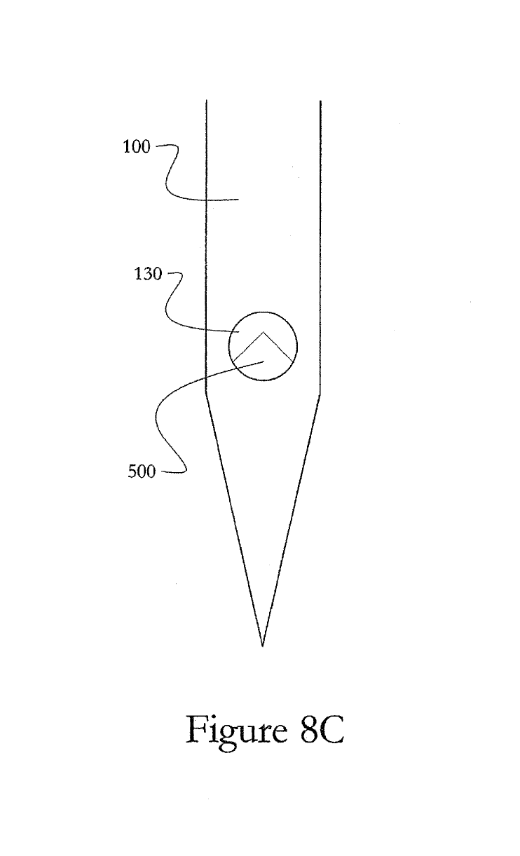

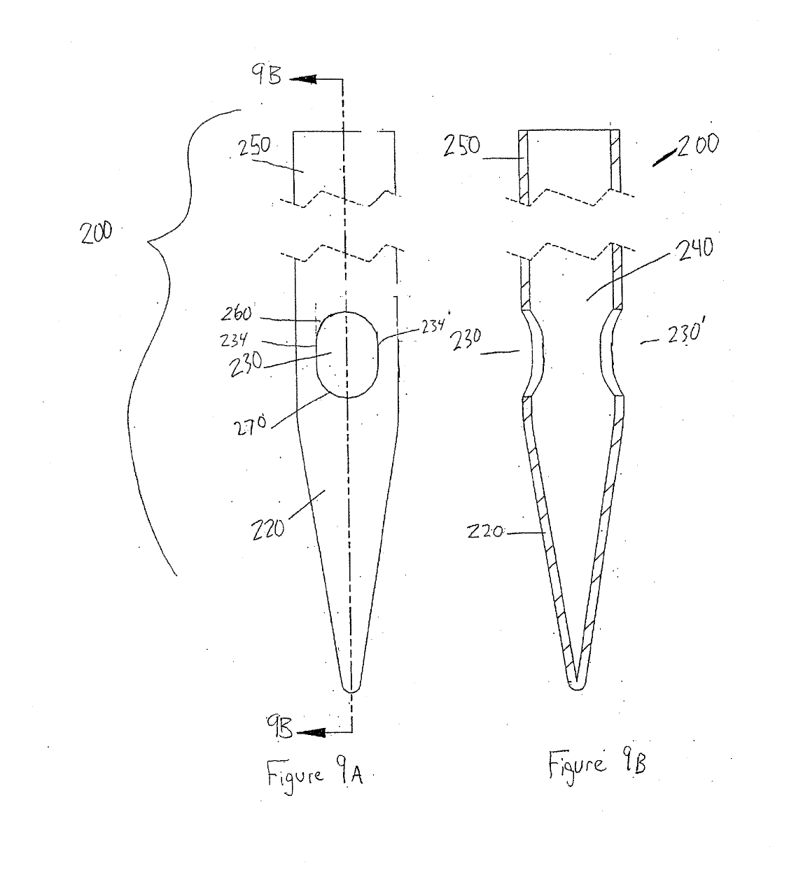

In an alternative preferred embodiment, only the trailing edge could be deflected inwardly to have a concave feature. Blockage of the inner bore of the needle within the distal tip does not necessarily obstruct flow through the needle as this region is not within the flow path between the side hole and the needle hub. Hence some amount of coring on withdrawal of the needle may be acceptable. Alternatively, the inner bore at the distal tip could be plugged as shown in FIGS. 8A and 8B, both blunting the leading edge from within the needle bore, and preventing the accumulation of material within the tip.

The embodiments described above discuss preferentially deflecting the edge of the side hole at the trailing and/or leading edge. Alternatively, the hole edge could be deflected about its entire periphery, or at additional select regions of the periphery depending upon the intended application. Various regions of the side hole edge could be deflected to a greater or lesser degree. For example, the trailing edge could be deflected toward the inner bore of the needle to a greater degree than the leading edge or vice versa.

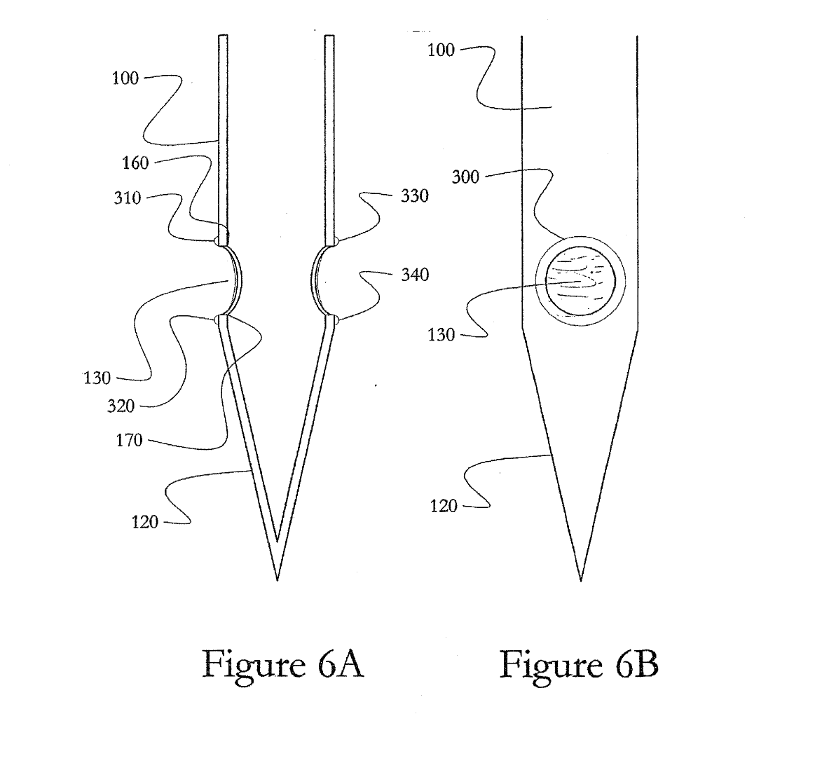

In another embodiment, a side hole of a needle according to one aspect of the invention may include an outwardly protruding or deflected edge at the outer surface of the needle, e.g., at or near the leading and/or trailing edges. FIGS. 6A and 6B depict an embodiment in which the full periphery of side hole 130 is deflected outwardly, in this case by a ring 300 placed onto the outer surface of the needle around the periphery of the side holes. This ring 300 acts to deflect material outward from the side hole edges as the needle traverses the material. This effectively blunts the edges of the side hole 130 and increases the distance the material must expand to extend into the inner bore 140 of the needle in order to be at risk of cutting or shearing. This ring 300 can be of uniform or varying thickness, e.g., the areas near the leading and trailing edges may be thicker than other sections. Variable thickness could be either continual or stepped or a combination of continual and stepped regions. Preferably, the thickness of the ring would be greatest at the leading edges 320 and 340 and trailing edges 310 and 330 of the side hole to minimize any increase in force to insert the needle through the material while also minimizing the risk of material coring or cutting. Alternatively, these rings could be placed within the bore of the needle 140 on the periphery of the side hole or holes, effectively blunting and deflecting the edge toward the inner bore 140 of the needle. The rings 300 are shown abutting the periphery of the hole 130 circumference. Alternatively, the rings could be of larger circumference than hole 130 and be displaced radially outward from the hole periphery, depending upon the intended application. Of course, the outwardly deflected edge of the side holes could be formed in other ways, such as by bending portions of the needle wall outwardly away from the needle bore, providing a rolled or bent edge formed of the needle wall material, etc.

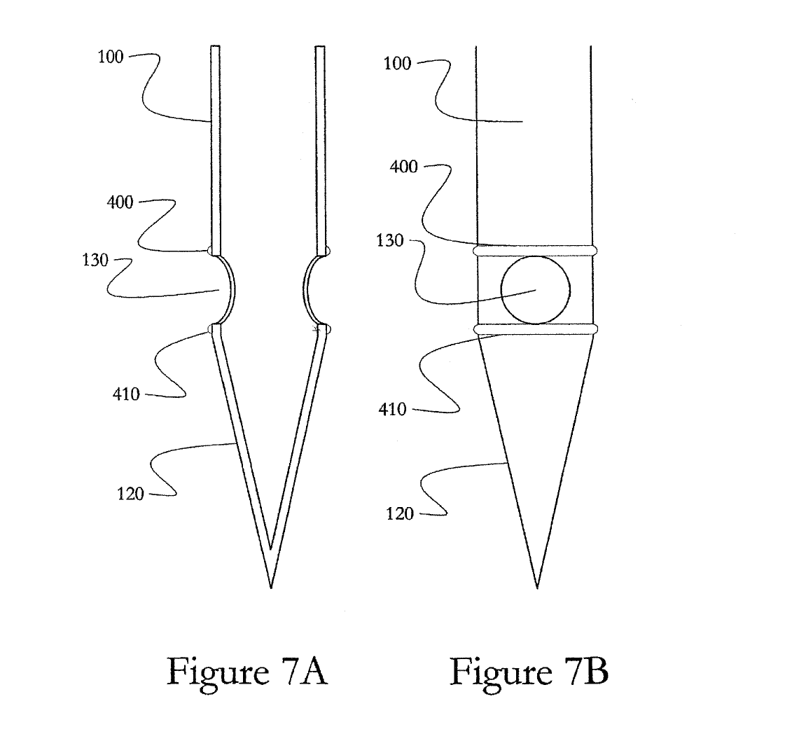

FIGS. 7A and 7B depict an alternate embodiment of the deflected side hole shown in FIGS. 6A and 6B. In this embodiment, two circumferential rings 400 and 410 are placed about the outer surface of the needle proximal to both the leading and trailing edges respectively of side holes 130. Each ring acts to effectively deflect the leading and trailing edges radially outward away from the needle body, both blunting the edge and deflecting traversed material away from the edge. Again, each ring could be of equal thickness around the outer circumference of the needle, or variable in thickness, preferentially being thickest proximal to the leading and trailing edges of hole 130. Further, the ring proximal to the leading edge 410 could be either the same thickness, of greater thickness or lesser thickness than the ring proximal to the trailing edge 400 depending upon the intended application. The rings are shown abutting the leading and trailing edges. Alternatively, either or both could be displaced along the long axis away from each edge by the same or a variable distance.

In another aspect of the invention, a hollow void within a needle tip is fitted with plug or filled in with a material. The plug or other element may effectively eliminate any cutting edge at the leading edge of the hole, e.g., by presenting a relatively wide and dull surface to the cork or other material being traversed. In other arrangements, the plug may help prevent the accumulation of material at the needle tip. FIGS. 8A-C depict an alternative embodiment of the present invention which employs a plug 500 within the conical tip 120 of the needle that acts to prevent cutting or shearing of material at the leading edge of the side holes and the trapping or accumulating of particles and debris therein. FIGS. 8A and 8B are enlarged cross-sectional views of the tip 120 before and after placement of the plug 500 respectively. FIG. 8C is an enlarged side view of the tip 1200 following placement of the plug.

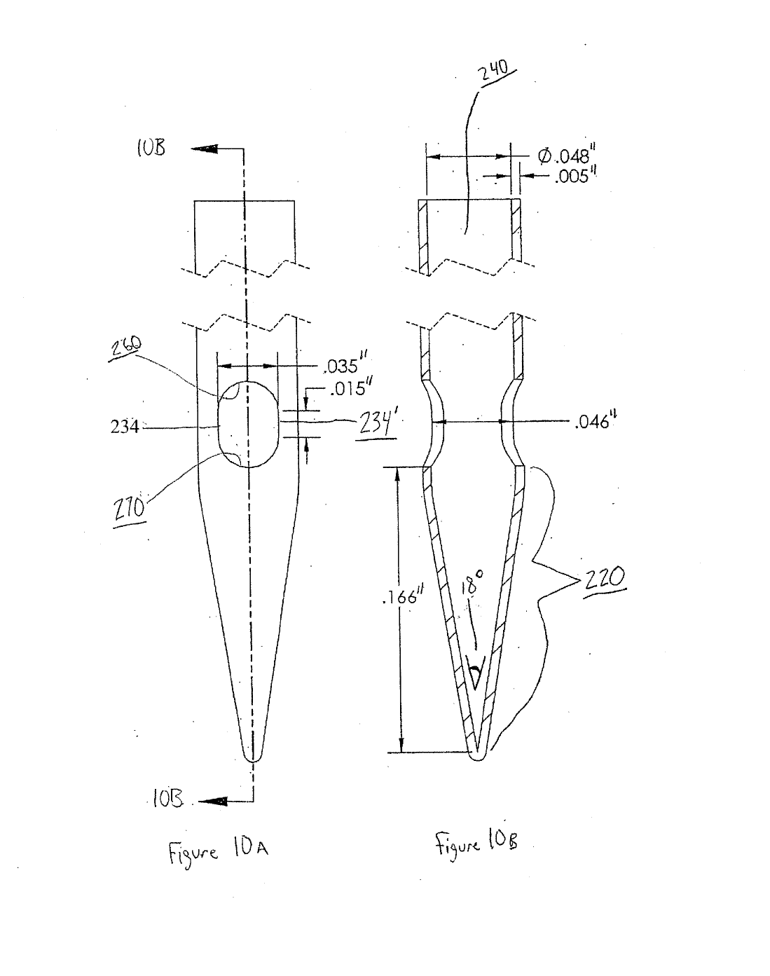

In accordance with another aspect of the invention, FIGS. 9A and 9B show a needle 200 with distal opposing oblong side holes 230, 230′ (as shown in the cross-section view in FIG. 9B) creating passages within the interior 240 of the needle body or cannula 250 proximal to the tangency between the needle body 250 and tip 220.

The oblong holes 230, 230′ may further be defined as having and upper and lower curved sections for the trailing edge 260 and the leading edge 270 which are connected by two opposing parallel vertical sections 234, 234′. The oblong shape of the holes 230,230′ in this and other embodiments can be beneficial in facilitating a relatively larger open area (compared to a circle) while minimizing the edge length that impacts shearing or cleaving as the needle is linearly inserted and removed from a material such as a cork. Additionally, such a design presents more vertical structure to remain on the needle shaft resulting in greater strength and presenting less of a focused bending point such as would be the case with a circle at its equator or diamond at its opposing side edges. Each of the opposing holes or apertures are generally sized in area to be equivalent to the area of the inner cross-section of the interior 240 of the needle body 250 or within 5-15% thereof to achieve a balance between maximum flow rate and needle integrity. Moreover, the apertures can also be sized to minimize the deflection of material into the hollow interior of the needle.

The positioning of the side holes or apertures in this and other embodiments relative to the tangency of the tip 220 and body 250 can be operable to optimize the overall length of the needle (keeping it short and stout) and prevents the possibility of coring. This is because the holes are as close as possible or adjacent to the tangency of the needle body to the tip without extending onto the tip and therefore exposing a sharpened axial edge of the hole at the tip. Moreover, the tip may act to deflect material away from the side hole due to its relative proximity.

In another aspect of the invention, the holes of the needle are positioned opposite each other to facilitate clearing of particles lodged therebetween by simply using an appropriately sized push rod to dislodge the particles out the opposing side. Access to the tip area (if hollow) is also enhanced by such a design. Further, such a design is operable to provided visible feedback that the apertures are clear since light will pass through upon inspection.

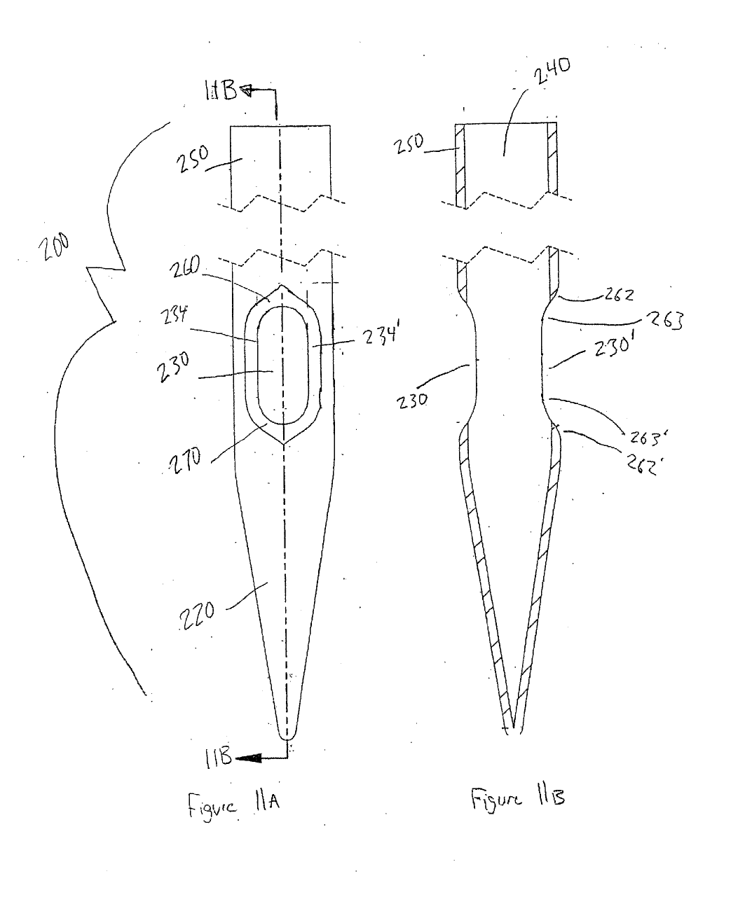

Turning to FIGS. 10A and 10B, the embodiment in FIGS. 9A and 9B is shown with preferred exemplary dimensions operable to access and deliver wine from sealed vessel as described herein. In this embodiment the inner diameter the needle interior 240 is 0.048 inches corresponding to a cross-sectional area of 0.0018 square inches, but could range from 0.04-0.05 inches in inner diameter. The length of the needle tip 220 is 0.166 inches and the included angle is 18 degrees. Optional needle profiles have be described infra. The area of the hole 230, 231′ is about equal to the aforementioned cross-sectional areal of the interior of the needle or between 0.001-0.0025 square inches. The length of the parallel vertical sections 234, 234′ of the hole are 0.15 inches, but could optionally range from 0.010-0.020 inches. Though the leading edge of the hole is shown adjacent the tangency between the needle tip and the needle body, it may optionally be located from 0-0.25 inches distally from the tangency, preferably between 0.01 and 0.1 inches from the tangency. FIG. 10B also shows that the cross-section of the holes is concave with respect to the sidewall of the needle or needle body.

The holes or apertures in the embodiment described in FIGS. 9 and 10 may optionally be formed by a perpendicular hole cut from top or bottom of the needle. Such a cut could be a plunge cut with a shaped electrode from utilizing a conventional or die-sinker electric discharge machining (EDM) machine As formed, in this embodiment the holes have straight sides and could be formed by a plunge straight through or a plunge halfway followed by flipping the part and plunging the other side.

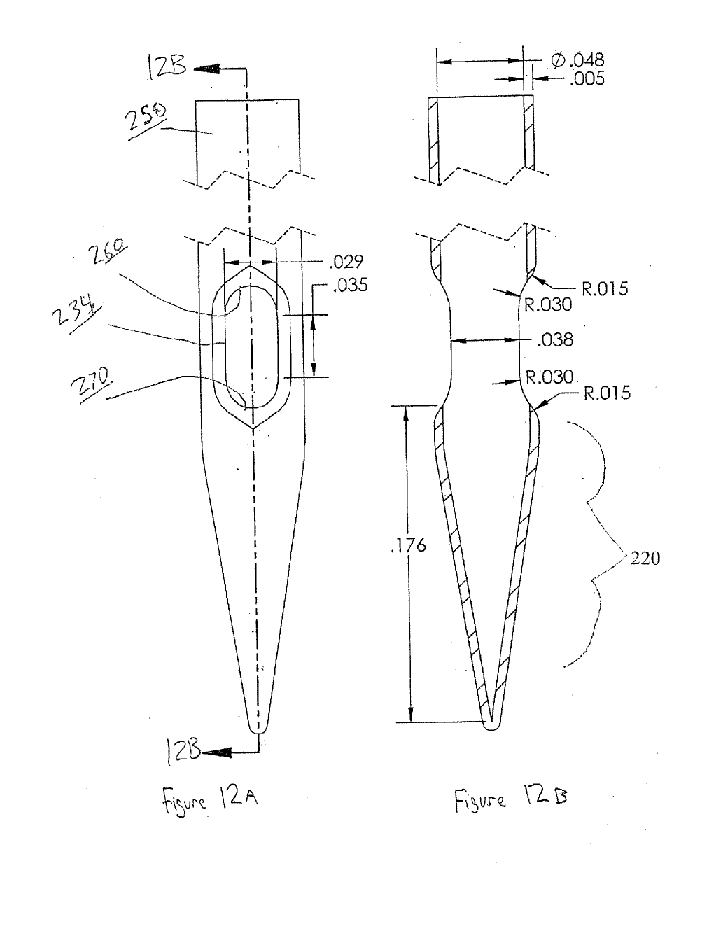

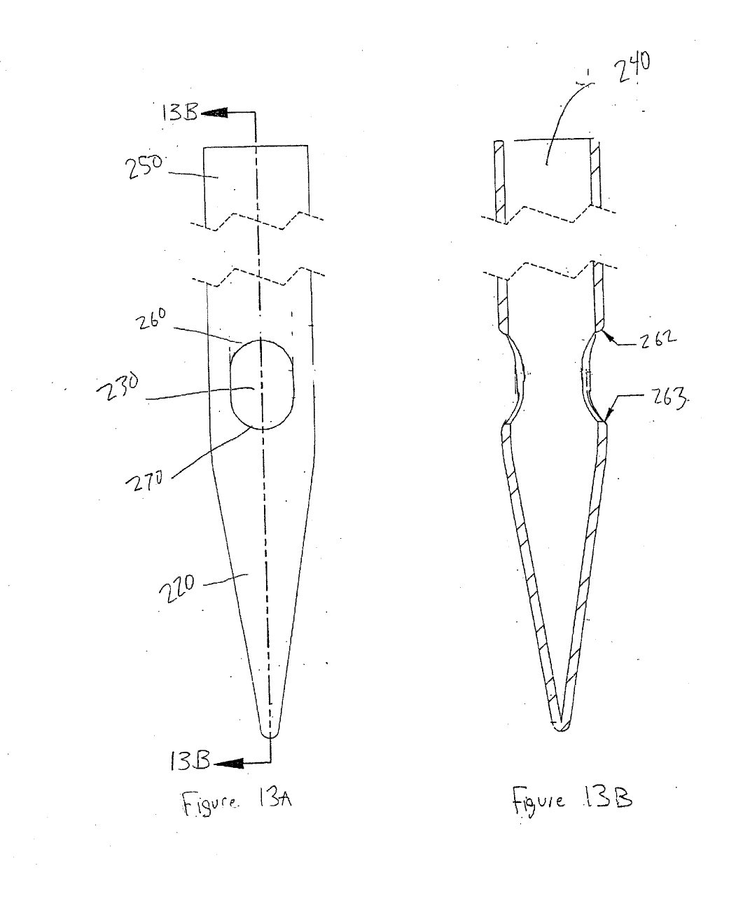

In another illustrative embodiment there is provided a needle having opposing oblong holes positioned proximal to the tip of the needle. In this embodiment, shown in FIGS. 11 and 12, the opposing holes are formed differently than those shown in FIGS. 9 and 10 but retain the overall nomenclature and generally oblong nature of the holes. Accordingly, FIGS. 12A and 12B show a needle 200 having opposing oblong holes 230, 230′ having trailing edge 260 and leading edge 270 connected by two opposing parallel vertical sections 234, 234′. However, in this embodiment, although the overall cross-sectional aspect of the holes is concave, the trailing and leading edge profiles are convex at the intersection with the needle body and then concave as they connect to the opposing straight vertical sections. Such a profile is particularly adapted to deflect particles and debris as the needle is inserted and retracted from a material.

Turning to FIGS. 12A and 12B, the embodiment in FIGS. 11A and 11B is shown with preferred exemplary dimensions operable to access and deliver wine from sealed vessel as described herein. In this embodiment the inner diameter the needle interior 240 is 0.048 inches corresponding to a cross-sectional area of 0.0018 square inches but could range from 0.04-0.05 inches. The length of the needle tip 220 is 0.166 inches and the included angle is 18 degrees. Optional needle profiles have be described infra. The area of the hole 230, 231′ is about equal to the aforementioned cross-sectional areal of the interior of the needle or between 0.001-0.0025 square inches. The length of parallel opposing vertical sections 234, 234′ of the hole are 0.035 inches but could optionally range from 0.025-0.045 inches.

In this embodiment, the lateral profile of the oblong holes is configured such that the leading and trailing edge of the aperture create a convex oriented radius of about 0.015 inches with the respect to the needle body wall 250 and then create a concave radius of about 0.030 inches with respect to the parallel opposing sides of the holes. Though the leading edge of the hole is shown adjacent the tangency between the needle tip and the needle body, it may optionally be located from 0-0.25 inches distally from the tangency, preferably between 0.01 and 0.1 inches from the tangency. Accordingly, in this embodiment the opposing apertures or holes present convex leading and trailing edges that include a concave portion connecting to straight side sections of the hole.

The holes or apertures in the embodiment described in FIGS. 11 and 12 may optionally be formed by wire EDM wherein a contoured hole is cut from side, i.e., the work part is placed perpendicular to the wire and wire is used to cut inwardly parallel along the length of the needle. Other means of forming the holes such as ECG and conventional EDM are also possible.

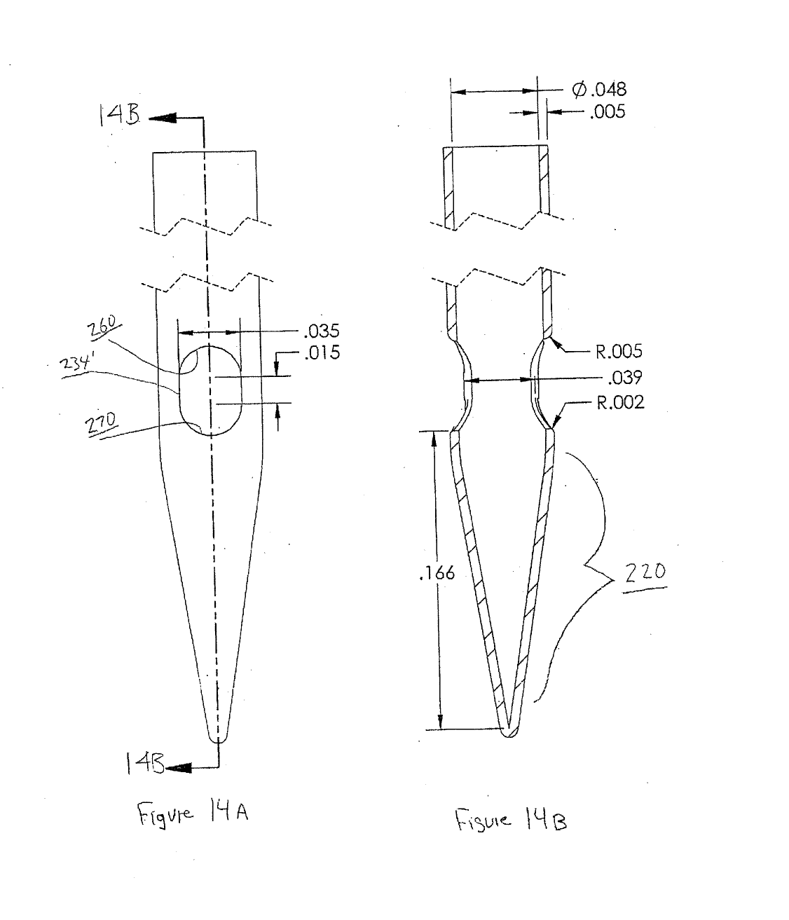

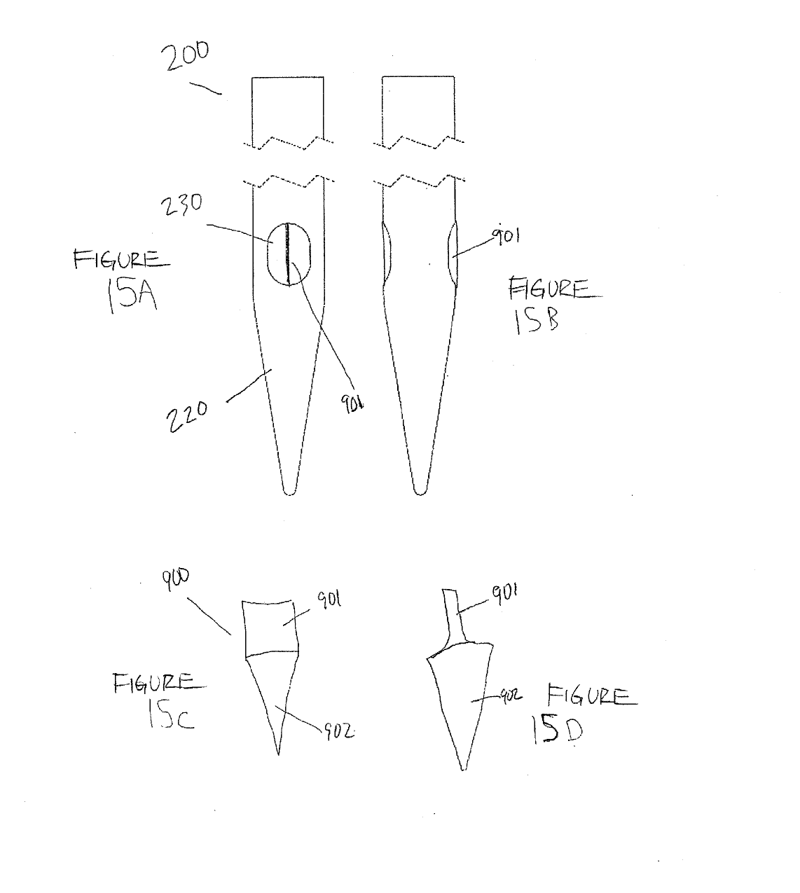

In another illustrative embodiment there is provided a needle having opposing oblong holes positioned proximal to the tip of the needle. In this embodiment, shown in FIGS. 13 and 14, the opposing holes are formed differently than those shown in FIGS. 9 and 10 but retain the overall nomenclature and generally oblong nature of the holes. Accordingly, FIGS. 13A and 13B show a needle 200 having opposing oblong holes 230, 230′ having trailing edge 260 and leading edge 270 connected by two opposing parallel vertical sections 234, 234′. However, in this embodiment, although the overall cross-sectional aspect of the holes is concave, the trailing and leading edge profiles are convex at the intersection with the needle body and then concave thereafter. Such a profile is particularly adapted to deflect particles and debris as the needle is inserted and retracted from a material.

Turning to FIGS. 14A and 14B, the embodiment in FIGS. 11A and 11B is shown with preferred exemplary dimensions operable to access and deliver wine from sealed vessel as described herein. In this embodiment, the inner diameter the needle interior 240 is 0.048 inches corresponding to a cross-sectional area of 0.0018 square inches but could range from 0.04-0.05 inches. The length of the needle tip 220 is 0.166 inches and the included angle is 18 degrees. Optional needle profiles have be described infra. The area of the hole 230, 231′ is about equal to the aforementioned cross-sectional areal of the interior of the needle or between 0.001-0.0025 square inches. The length of parallel opposing vertical sections 234, 234′ of the hole are 0.015 inches but could optionally range from 0.010-0.020 inches.

In this embodiment, the lateral profile of the oblong holes is configured such that the trailing edge of the aperture create a convex radius of about 0.005 inches with the respect to the needle body wall 250 and the leading edge of the aperture creates a convex radius of about 0.002 inches with respect to the needle body. The profile of the hole between the convex potions of the leading and trailing edges is generally concave. Though the leading edge of the hole is shown adjacent the tangency between the needle tip and the needle body, it may optionally be located from 0-0.25 inches distally from the tangency, preferably between 0.01 and 0.1 inches from the tangency. Accordingly, in this embodiment the opposing apertures or holes present concave/convex leading and trailing edges along the long axis of the needle (depending on whether the needle is being inserted or retracted) and a convex leading and trailing edge along a lateral or perpendicular axis of the aperture connected by opposing concave sections.

While one or more embodiments of the invention has been illustrated and described in detail in the drawings and foregoing description, the same is to be considered illustrative and not restrictive in character, it being understood that only the preferred embodiments have been shown and describes and that all changes and modifications that come within the spirit of the invention are desired to be protected.

1. A needle for penetrating a corked vessel and extracting a fluid therefrom comprising:
a hollow needle body terminating in a closed end non-coring tip portion at a distal end of the body; and
two opposing side apertures located in said body proximal said tip portion;
said opposing apertures being oblong in shape with respect to the long axis of the needle wherein each said aperture presents a convex leading edge and a concave trailing edge along said long axis.

2. The needle in claim 1, wherein each of said opposing apertures equal to or within 5-15% of the cross-sectional area of the hollow interior of said needle.

3. The needle in claim 1, wherein the apertures are positioned between 0.01 and 0.1 inches from a tangency between the needle body and the tip.

4. The needle in claim 1, further comprising a plug mounted within said tip operable to prevent particles from lodging therein.

5. The needle in claim 1, further comprising a septum bifurcating said holes and at least a portion of said needle, wherein said septum is operable to deflect particles and prevent them from entering said aperture.

6. The needle in claim 1 wherein said opposing apertures are operable to provide visual feedback of particulate blockage therein.

7. The needle of claim 1, wherein the side apertures are oblong in shape with straight side sections.

8. The needle of claim 1, wherein the concave trailing edges are formed by deflecting a portion of the body inwardly at the trailing edge of the aperture.

9. The needle of claim 1, wherein the convex leading edges are formed by material buildup on an outer surface of the body adjacent the leading edges of the apertures.

10. The needle of claim 1, wherein the trailing edge has a convex transition to side edges of the aperture.

11. A needle for penetrating a corked vessel and extracting a fluid therefrom comprising:
a hollow needle body terminating in a closed end non-coring tip portion at a distal end of the body; and
two opposing side apertures located in said body proximal said tip portion;
wherein each said aperture presents a convex leading edge and a convex trailing edge along an axis perpendicular to the long axis, said convex edges operable to at least partially deflect said cork from entering said apertures and wherein said apertures are sized to limit deflection of cork therein.

12. The needle in claim 1, wherein each of said opposing apertures equal to or within 5-15% of the cross-sectional area of the hollow interior of said needle.

13. The needle in claim 1, wherein the apertures are positioned between 0.01 and 0.1 inches from a tangency between the needle body and the tip.

14. The needle in claim 1, further comprising a plug mounted within said tip operable to prevent particles from lodging therein.

15. The needle in claim 1, further comprising a septum bifurcating said holes and at least a portion of said needle, wherein said septum is operable to deflect particles and prevent them from entering said aperture.

16. The needle in claim 1 wherein said opposing apertures are operable to provide visual feedback of particulate blockage therein.

17. The needle of claim 1, wherein the side apertures are oblong in shape with straight side sections.

18. The needle of claim 1, wherein the convex leading and trailing edges are formed by material buildup on an outer surface of the body adjacent the leading edges of the apertures.

19. The needle of claim 1, wherein the trailing edge has a concave transition to straight side sections of the aperture.

20. A needle for penetrating a corked vessel and extracting a fluid therefrom comprising:
a hollow needle body terminating in a closed end non-coring tip portion at a distal end of the body; and
two opposing side apertures located in said body proximal said tip portion;
wherein each said aperture presents a concave leading edge and a concave trailing edge along an axis perpendicular to the long axis, said concave edges operable to resist deflection of cork into the apertures with movement of the needle body in cork.

21. A method of reducing the shearing off of particles with the leading and trailing edges of opposing side mounted apertures on a cannulated needle for extracting beverage from a container, comprising:
forming opposing oblong apertures along and through a sidewall of said cannulated needle;
wherein said opposing apertures are oblong in shape with respect to the long axis of the cannulated needle and wherein said apertures presents a convex or concave leading edge and a concave or convex trailing edge along said long axis;
inserting and removing said needle within material along a linear path parallel to the long axis of the needle; and
deflecting said material and particles thereof from said apertures with said edges and limiting material from entering said apertures.

22. The method in claim 21 further comprising the step of providing visual feedback of particulate blockage within said apertures.
